(19) United States
(12) Patent Application Publication
(10) Pub. No.: US 2024/0408779 A1
(43) Pub. Date: Dec. 12, 2024

(54) RAZOR CARTRIDGE

(71) Applicant: DORCO CO., LTD., Yongin-si (KR)

(72) Inventor: Da Woon HAN, Seoul (KR)

(21) Appl. No.: 18/678,443

(22) Filed: May 30, 2024

(30) Foreign Application Priority Data
Jun. 9, 2023 (KR) 10-2023-0074314

(51) Int. Cl. B26B 21/22; B26B 21/40; B26B 21/44

(52) U.S. Cl. CPC B26B 21/222; B26B 21/4018; B26B 21/443

(57) ABSTRACT

A razor cartridge is proposed. The razor cartridge may include a blade housing for accommodating at least one razor blade having a cutting edge in a longitudinal direction, the blade housing comprising a top surface and a bottom surface opposing the top surface. The cartridge may also include a clip comprising a clip body disposed on the top surface and configured to retain the at least one razor blade, a first elongated portion extending from the clip body toward the bottom surface, and a second elongated portion extending from one end of the first elongated portion in a direction away from the center of the clip body. The cartridge may further include a cover housing configured to be combined with the blade housing in a direction from the top surface to the bottom surface, wherein the second elongated portion is disposed between the blade housing and the cover housing.

### CROSS REFERENCE TO RELATED APPLICATIONS

This patent application claims priority to Patent Application No. 10-2023-0074314, filed in Korea on Jun. 9, 2023, which is incorporated herein by reference in its entirety.

### BACKGROUND

### Technical Field

The present disclosure relates to a razor cartridge.

### Description of Related Technology

A razor cartridge includes a razor blade having a cutting edge, a blade housing to accommodate the razor blade, and a clip to retain the razor blade in the blade housing. Herein, a portion of the clip faces the razor blade, and the remaining portion surrounds the blade housing or penetrates at least a portion thereof, so that the clip may be fixed to the blade housing.

### SUMMARY

One aspect is a razor cartridge configured to reduce manufacturing costs

by fixing a clip to a blade housing through a simple process and simultaneously enable the clip to be separated for discharge.

Another aspect is a razor cartridge, comprising: a blade housing for accommodating at least one razor blade having a cutting edge in a longitudinal direction, the blade housing comprising a top surface toward which the cutting edge faces and a bottom surface opposing the top surface; a clip comprising a clip body disposed on the top surface and configured to retain the at least one razor blade in the blade housing, a first elongated portion that extends from the clip body toward the bottom surface, and a second elongated portion that extends from one end of the first elongated portion in a direction away from the center of the clip body; and a cover housing configured to be combined with the blade housing in a direction from the top surface to the bottom surface, wherein the second elongated portion is disposed between the blade housing and the cover housing.

As described above, according to various embodiments of the present disclosure, there is provided a razor cartridge configured to reduce manufacturing costs by fixing a clip to a blade housing through a simple process and simultaneously enable the clip to be separated for discharge.

### BRIEF DESCRIPTION OF THE DRAWINGS

FIG. 1 is an exploded perspective view of a razor cartridge according to an embodiment of the present disclosure.

FIG. 2 is a top perspective view of a razor cartridge according to an embodiment of the present disclosure.

FIG. 3 is a bottom perspective view of a razor cartridge according to an embodiment of the present disclosure.

FIG. 4 is a side view of a razor cartridge according to an embodiment of the present disclosure.

FIG. 5 is a cross-sectional view of the razor cartridge of FIG. 2 viewed from the side surface, taken in a direction of A-A′.

FIG. 6 is a side cross-sectional view of a state before a blade housing and a cover housing are combined.

FIG. 7 is a cross-sectional view of a razor cartridge according to another embodiment of the present disclosure in the same manner as FIG. 5.

### DETAILED DESCRIPTION

In a current razor blade clip, a process of surrounding one side surface of the blade housing or bending the end penetrating the blade housing on a bottom surface of the blade housing needs to be performed. In addition, when a portion of the clip penetrates the blade housing, a process of inserting and penetrating the portion of the clip into a penetration hole of the blade housing also needs to be performed. Accordingly, there is considerable inconvenience in assembling the conventional clip into the blade housing, and the assembly process is also difficult, resulting in a high incidence of defective products.

Additionally, the clip is generally made of a metal material, and the blade housing is generally made of a plastic material. Accordingly, when a razor cartridge is separately collected or recycled, it is desirable that the clip and blade housing are separated from each other and discharged separately. However, when a metal clip is inserted into or penetrates a plastic housing, like a conventional clip, it is quite difficult to separate the clip from the razor cartridge and discharge the same.

Hereinafter, some embodiments of the present disclosure will be described in detail with reference to the accompanying drawings. It is to be noted that in giving reference numerals to components of each of the accompanying drawings, the same components will be denoted by the same reference numerals even though they are illustrated in different drawings. Further, in describing exemplary embodiments of the present invention, well-known functions or constructions will not be described in detail since they may unnecessarily obscure the understanding of the present invention.

Terms ‘first’, ‘second’, i), ii), a), b), and the like, will be used in describing components according to embodiments of the present disclosure. These terms are only for distinguishing the components from other components, and the nature, sequence, order, or the like of the components are not limited by the terms. Throughout the present specification, unless explicitly described to the contrary, “including” or “comprising” any components will be understood to imply the inclusion of other elements rather than the exclusion of any other elements.

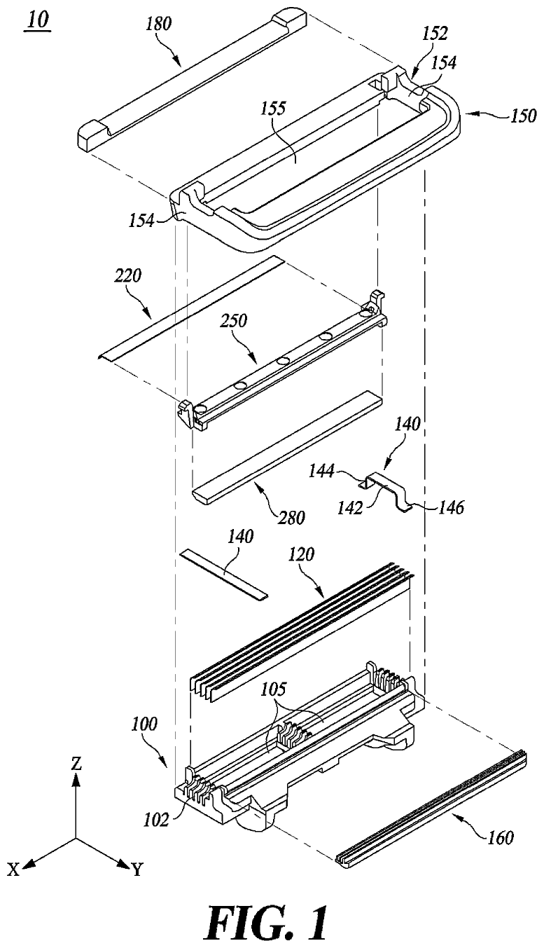

FIG. 1 is an exploded perspective view of a razor cartridge 10 according to an embodiment of the present disclosure.

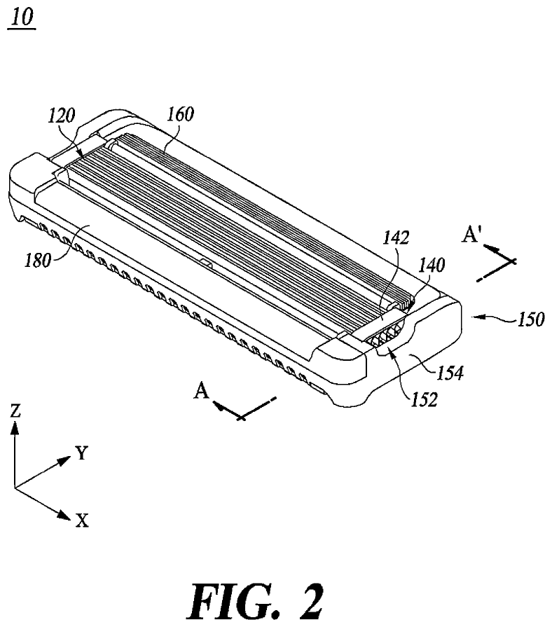

FIG. 2 is a top perspective view of the razor cartridge 10 according to an embodiment of the present disclosure.

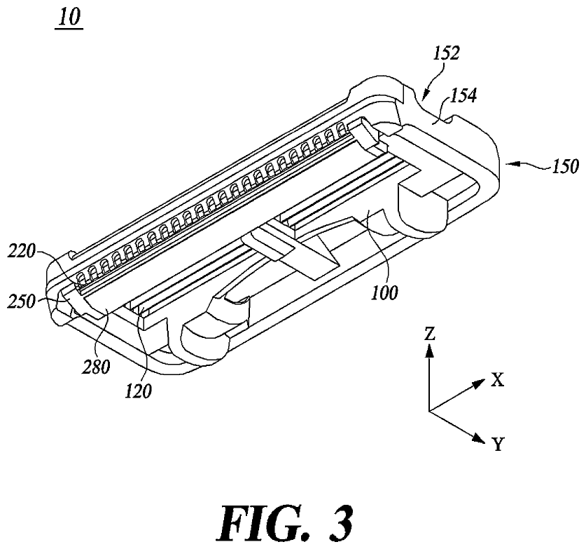

FIG. 3 is a bottom perspective view of the razor cartridge 10 according to an embodiment of the present disclosure.

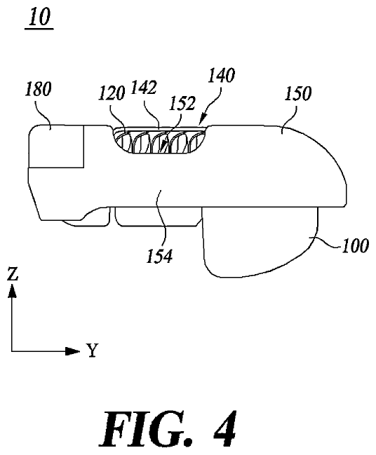

FIG. 4 is a side view of the razor cartridge 10 according to an embodiment of the present disclosure.

Referring to FIGS. 1 to 4, the razor cartridge 10 according to an embodiment of the present disclosure includes all or part of at least one razor blade 120, a blade housing 100, a clip 140, and a cover housing 150, a guard 160, and a first lubrication band 180. In addition, according to an embodiment of the present disclosure, the razor cartridge 10 further includes all or part of at least one trimming blade 220, a trimmer cap 250, and a second lubrication band 280.

The at least one razor blade 120 has a cutting edge (not shown). The cutting edge may extend in a longitudinal direction, where the longitudinal direction may mean, for example, a direction parallel to the X-axis in FIGS. 1 to 3. In FIGS. 1 to 4, the number of the at least one razor blade 120 is illustrated to be 5, but the number is not necessarily limited to this number.

The blade housing 100 accommodates the at least one razor blade 120 in the longitudinal direction and includes a top surface (not shown) toward which the cutting edge faces and a bottom surface (not shown) opposing the top surface. Herein, the top and bottom surfaces may be opposite to each other in a height direction. Herein, the height direction may mean, for example, a direction parallel to the Z-axis in FIGS. 1 to 4.

The blade housing 100 may include at least one blade accommodation portion 102 extending at least partially in the height direction to support one surface of the at least one razor blade 120 in a lateral direction. Herein, the lateral direction may mean, for example, a direction parallel to the Y-axis in FIGS. 1 to 4.

The blade housing 100 may include at least one penetration hole 105 that penetrates in the height direction through at least a portion of the region where the at least one razor blade 120 is seated.

For example, rinsing water flowing in from the top surface may pass through the bottom surface through the at least one razor blade 120, and thus, shaving residue present in the razor cartridge 10 after shaving may be discharged to the bottom surface through the penetration hole 105.

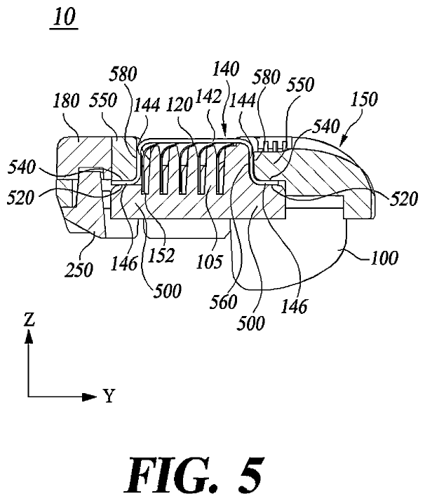

The clip 140 may include a clip body 142, a first elongated portion 144, a second elongated portion 146, and a third elongated portion 148. A detailed description thereof will be provided later with reference to FIGS. 5 to 7.

The cover housing 150 is configured to be combined with the blade housing 100 in a direction from the top surface to the bottom surface. For example, the cover housing 150 may be combined with the blade housing 100 in a detachable manner.

As such, the razor cartridge 10 according to an embodiment of the present disclosure is configured so that the blade housing 100 and the cover housing 150 are combined as separate components rather than integrated. Hence, when the blade housing 100 and the cover housing 150 may be separated from each other, it is easier to separate and discharge various components.

In particular, in the case of a general razor cartridge, there is an issue in that the plastic housing and the metal razor blade or clip are not easily separated from each other for discharge. However, in the case of the razor cartridge 10 according to an embodiment of the present disclosure, this issue may be addressed.

The cover housing 150 may include a central opening portion 155 configured to allow at least a portion of the blade housing 100 to pass through a central region of the cover housing 150. The cutting edge of the at least one razor blade 120 may be exposed to the outside on the top surface through the central opening portion 155.

The central opening portion 155 may be in communication with the at least one penetration hole 105 of the blade housing 100, and accordingly, the rinsing water flowing in from an adjacent region on the top or bottom surface passes through the central opening portion 155 and/or the at least one penetration hole 105, thereby allowing shaving residue to be discharged.

The cover housing 150 may include a pair of side openings 152 formed on both longitudinal side areas of the cover housing 150 to allow rinsing water to pass through the blade housing 100 in a region adjacent to both longitudinal side surfaces of the at least one razor blade 120.

For example, rinsing water flowing in from the side opening 152 on one longitudinal side of the cover housing 150 may pass through the at least one razor blade 120 and through the side opening 152 on the other longitudinal side.

Accordingly, the shaving residue present in the razor cartridge 10 after shaving may not only be discharged to the bottom surface through the at least one penetration hole 105 and/or the central opening portion 155, but also be discharged to a side surface through the pair of side openings 152. Thereby, more effective discharge is possible.

In addition, the cover housing 150 may include a pair of side walls 154 disposed below each of the pair of side openings 152 and configured to support at least a portion of one longitudinal side surface of the at least one razor blade 120 when the blade housing 100 is viewed from one longitudinal side.

In this connection, each of the pair of side walls 154 may be configured to extend from a lower surface in the height direction of the cover housing 150 toward an upper surface. Accordingly, the side wall 154 may be formed to have a predetermined height, but the side wall 154 does not necessarily have to extend from the lower surface of the cover housing 150 in the height direction to have a constant height.

For example, referring to FIG. 4, based on the lateral direction, the height of both ends of the side wall 154 in the lateral direction may be configured to be greater than the height of the center. Since the side wall 154 supports at least a portion of one longitudinal side surface of the at least one razor blade 120, the at least one razor blade 120 may be prevented from moving in the longitudinal direction.

The guard 160 is disposed on one surface adjacent to the top surface. For example, the guard 160 may be disposed in front of the at least one razor blade 120. The front and rear may be defined based on the shaving direction of the razor cartridge 10, and may be parallel to the lateral direction. The front may mean a positive Y-axis direction, and the rear may mean a negative Y-axis direction.

The guard 160 may stretch the skin before the body hair is cut by the at least one razor blade 120 during a shaving process, and the guard 160 may allow the body hair of a user to stand in a direction perpendicular to the skin surface of the user. Thereby, cutting of body hair by the at least one razor blade 120 may become easier.

Referring to FIGS. 1 and 2, the guard 160 according to an embodiment of the present disclosure is illustrated as being disposed on the blade housing 100, but is not necessarily limited thereto, and the guard 160 may also be disposed on the cover housing 150.

The first lubrication band 180 is disposed on one surface adjacent to the top surface. For example, the first lubrication band 180 may be disposed in rear of the at least one razor blade 120. The first lubrication band 180 may include a lubricating material, and thus may serve to protect the skin of a user during shaving.

Referring to FIGS. 1 and 2, the first lubrication band 180 according to an embodiment of the present disclosure is illustrated as being disposed on the cover housing 150, but is not necessarily limited thereto, and the first lubrication band 180 may also be disposed on the blade housing 100.

However, when the first lubrication band 180 is disposed on the cover housing 150, one end in the longitudinal direction of the first lubrication band 180 may be disposed more adjacent to one end in the longitudinal direction of the cover housing 150 than one end in the longitudinal direction of the clip 140.

For example, a longitudinal width of the first lubrication band 180 may be equal to or greater than a longitudinal distance between the pair of clips 140 disposed on both sides of the at least one razor blade 120, and may be equal to or smaller than the longitudinal width of the cover housing 150.

In this connection, the region where the first lubrication band 180 comes into contact with the skin of a user may become wider, and thus it is possible to apply the lubricating material to a wider range of the skin.

In addition, it is possible for the first lubrication band 180 to be shorter than the longitudinal distance between the pair of clips 140 disposed on both sides of the at least one razor blade 120.

At least one trimming blade 220 may be disposed on one surface adjacent to the bottom surface and may have a trimming edge (not shown) extending in the longitudinal direction. In this connection, the side where the trimming edge of the at least one trimming blade 220 faces and the side where the cutting edge of the at least one razor blade 120 faces may be opposite to each other.

The trimming blade 220 is effective in providing precise trimming shaving to regions of skin that have many curves or regions that require precise shaving, for example, under the nose, near the ears, and skin regions near the ears.

In addition, the at least one trimming blade 220 may be configured to be seated on the cover housing 150, but is not necessarily limited thereto, and may also be configured to be seated on the blade housing 100.

The trimmer cap 250 may be fixed to the cover housing 150 or the blade housing 100 to provide retention force on one surface of the trimming blade 220. The second lubrication band 280 may include a lubricating material, and thus may serve to protect the skin of a user during trimming and shaving.

FIG. 5 is a cross-sectional view of the razor cartridge 10 of FIG. 2 viewed from the side surface, taken in a direction of A-A′.

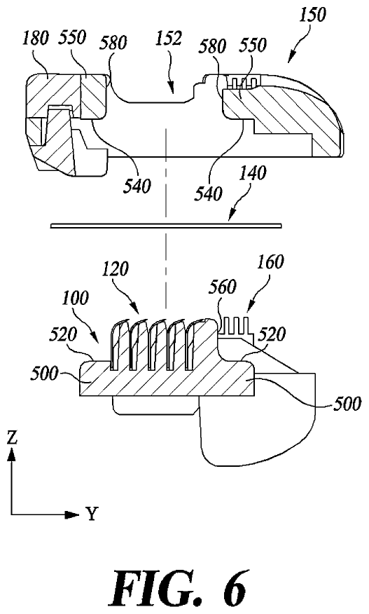

FIG. 6 is a side cross-sectional view of a state before the blade housing 100 and the cover housing 150 are combined.

Referring to FIGS. 5 and 6, the clip body 142 is disposed on the top surface and is configured to retain the at least one razor blade 120 in the blade housing 100. For example, the clip body 142 may press the at least one razor blade 120 in a direction from the top surface to the bottom surface on one longitudinal side of the at least one razor blade 120.

The first elongated portion 144 extends from the clip body 142 toward the bottom surface, and the second elongated portion 146 extends from one end of the first elongated portion 144 in a direction away from the center of the clip body 142. For example, the clip 140 may be configured such that the first elongated portion 144 and the second elongated portion 146 are formed in order from the clip body 142 toward to one side in the lateral direction.

An extension direction of the first elongated portion 144 and an extension direction of the second elongated portion 146 may be different from each other. For example, the extension direction of the first elongated portion 144 may be approximately parallel to the height direction, and the extension direction of the second elongated portion 146 may be perpendicular to each other in a direction approximately parallel to the lateral direction, without being necessarily limited thereto.

The second elongated portion 146 may be disposed between the blade housing 100 and the cover housing 150. In more detail, an upper portion of the second elongated portion 146 may be supported by the cover housing 150, and a lower portion of the second elongated portion 146 may be supported by the blade housing 100. Accordingly, a position of the clip 140 may be fixed and the pressure on the at least one razor blade 120 may be maintained.

In addition, since one end of the first elongated portion 144 and one end of the second elongated portion 146 may be disposed between the top and bottom surfaces, the end of the clip 140 may not be exposed to the outside. In addition, the position of the clip 140 may be fixed and damage to the clip 140 may be prevented.

Since the clip 140 according to an embodiment of the present disclosure includes the first elongated portion 144 and the second elongated portion 146, the clip 140 may not be easily separated even when force is applied in the direction from the lower portion to the upper portion.

When the extension directions of the first elongated portion 144 and the second elongated portion 146 are perpendicular to each other, for example, when the extension direction of the first elongated portion 144 is approximately parallel to the height direction, and the extension direction of the second elongated portion 146 is approximately parallel to the lateral direction, position-fixing of the clip 140 and maintaining pressing force on the at least one razor blade 120 may be achieved more effectively.

In addition, the position of the clip 140 may be fixed by combining the blade housing 100 and the cover housing 150.

In the case of a conventional clip, the clip had to be fixed to the blade housing by inserting one end of the clip into a hole formed in the blade housing or by surrounding at least a portion of the blade housing by the clip. Accordingly, the process of assembling the clip into the blade housing was difficult, resulting in a high incidence of defective products.

In the case of the razor cartridge 10 according to an embodiment of the present disclosure, the clip 140 is disposed between the blade housing 100 and the cover housing 150, and then the blade housing 100 and the cover housing 150 are combined. Then, the position of the clip 140 may be fixed. Accordingly, there is a benefit in that the clip 140 may be position-fixed using a simple combining process.

The first elongated portion 144 and the second elongated portion 146 may be formed by combining the blade housing 100 and the cover housing 150. For example, referring to FIGS. 1 and 6, before the blade housing 100 and the cover housing 150 are combined, the clip 140 according to an embodiment of the present disclosure may be flat and unbent while being extended lengthwise in a direction approximately parallel to the lateral direction.

In the unbent state, the clip 140 has one surface seated on the blade housing 100 and the other surface pressed by the cover housing 150 to form the first elongated portion 144 and the second elongated portion 146. Accordingly, using a simple combination process, the position of the clip 140 may be fixed and the pressing force on the at least one razor blade 120 may be maintained.

However, the first elongated portion 144 and the second elongated portion 146 do not necessarily have to be formed only by combining the blade housing 100 and the cover housing 150. It is also possible that the clip 140 is configured to include the first elongated portion 144 and the second elongated portion 146 beforehand before the blade housing 100 and the cover housing 150 are combined.

In addition, at least a portion of the clip body 142 may be exposed to the outside on the top surface. For example, a region near the center of the clip body 142 may be exposed to the outside, and the first elongated portion 144 and the second elongated portion 146 may not be exposed to the outside.

In the case of a conventional razor cartridge, a clip is disposed on a housing made of plastic, which increases the overall thickness of the razor cartridge, and the contact of the thick clip makes it difficult for the cutting edge of the razor blade to contact the skin of a user.

The razor cartridge 10 according to an embodiment of the present disclosure is configured such that at least a portion of the clip 140 is exposed to the outside, thereby reducing the overall thickness of the razor cartridge 10. Thereby, this issue may be addressed. In addition, the clip 140 may be made of a metal material that is more prone to oxidation than the at least one razor blade 120, thereby preventing the issue of rusting of the at least one razor blade 120 of a razor mainly used in a humid bathroom.

The blade housing 100 may include a first support portion 500, and the cover housing 150 may include a second support portion 550.

The first support portion 500 may include a first support surface 520 formed at front and/or rear of the blade housing 100, at least a portion of which is configured to support a lower portion of the second elongated portion 146. For stable support, it may be desirable for the first support surface 520 to be approximately parallel to the extension direction of the second elongated portion 146, without being necessarily limited thereto.

The second support portion 550 may include a second support surface 540, at least a portion of which is configured to support an upper portion of the second elongated portion 146 and is approximately parallel to the extension direction of the first support surface 520.

In this connection, in at least one region of the razor cartridge 10 according to an embodiment of the present disclosure, the first support portion 500, the second elongated portion 146, and the second support portion 550 may be disposed sequentially along the height direction from the bottom surface to the top surface. Accordingly, the first support portion 500 and the second support portion 550 may prevent the clip 140 from moving in the height direction.

In addition, the blade housing 100 may include a first stop surface 560, and the cover housing 150 may include a second stop surface 280.

The first stop surface 560 may be formed at front and/or rear of the blade housing 100 so that at least a portion thereof supports one surface of the first elongated portion 144. For example, referring to FIG. 5, the first stop surface 560 may support one surface of the first elongated portion 144 in the lateral direction, thereby preventing the clip 140 from moving in the lateral direction. In order to prevent the clip 140 from moving in the lateral direction, it may be desirable for the clip 140 to be approximately parallel to the extension direction of the first elongated portion 144 of the first stop surface 560, without being necessarily limited thereto.

In FIG. 5, the first stop surface 560 is illustrated as being formed at front of the blade housing 100, but may also be formed at rear of the blade housing 100.

For example, a blade support portion 102 may be additionally formed at rear of the rearmost razor blade of the at least one razor blade 120. In this connection, one surface of the blade support portion 102 supporting the rearmost blade may form the first stop surface 560.

The second stop surface 580 may be opposite to at least a portion of the blade housing 100, at least a portion of which is configured to support the other surface of the first elongated portion 144. For example, the second stop surface 580 may be opposite to the first stop surface 560 in the lateral direction, and in this connection, in at least one region of the razor cartridge 10 according to an embodiment of the present disclosure, the first stop surface 560, first elongated portion 144, and the second stop surface 580 may be formed in order along a direction approximately parallel to the lateral direction.

Accordingly, the first stop surface 560 and/or the second stop surface 580 may prevent the clip 140 from moving in the lateral direction.

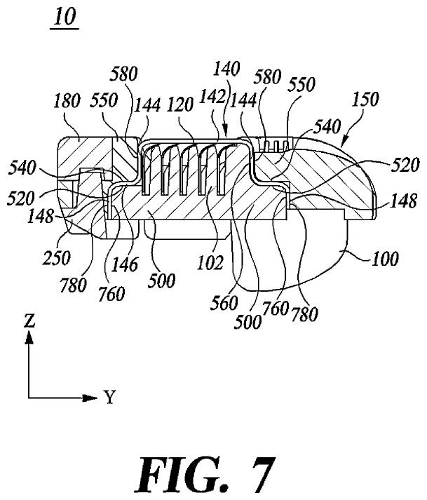

FIG. 7 is a cross-sectional view of a razor cartridge 20 according to another embodiment of the present disclosure in the same manner as FIG. 5.

The razor cartridge 20 according to another embodiment of the present disclosure is different from the razor cartridge 10 according to an embodiment of the present disclosure in that the clip 140 includes a third elongated portion 148. Except for matters specifically described below, the description of the razor cartridge 20 according to another embodiment of the present disclosure may be applied in the same manner as the description of the razor cartridge 10 according to an embodiment of the present disclosure described above.

The clip 140 according to another embodiment of the present disclosure may further include the third elongated portion 148, and the third elongated portion 148 extends from one end of the second elongated portion 146 toward the bottom surface. In this connection, the length of the clip 140 according to another embodiment of the present disclosure, based on the unbent state, may be longer than the length of the clip 140 according to an embodiment of the present disclosure.

The extension direction of the third elongated portion 148 and the extension direction of the second elongated portion 146 may be different from each other. For example, the extension direction of the third elongated portion 148 may be approximately parallel to the height direction, and the extension direction of the second elongated portion 146 may be approximately perpendicular to each other in a direction approximately parallel to the lateral direction, without being necessarily limited thereto.

Like one end of the first elongated portion 144 and one end of the second elongated portion 146, one end of the third elongated portion 148 may be disposed between the top and bottom surfaces, so that the end of the clip 140 may not be exposed to the outside, the position of the clip 140 may be fixed, and damage to the clip 140 may be prevented.

In addition, when the extension directions of the third elongated portion 148 and the second elongated portion 146 are approximately perpendicular to each other, for example, when the extension direction of the third elongated portion 148 is approximately parallel to the height direction, and the extension direction of the second elongated portion 146 is approximately parallel to the lateral direction, position-fixing of the clip 140 and maintaining pressing force on the at least one razor blade 120 may be achieved more effectively.

The third elongated portion 148 may be formed by combining the blade housing 100 and the cover housing 150. For example, referring to FIGS. 1 and 7, before the blade housing 100 and the cover housing 150 are combined, the clip 140 according to an embodiment of the present disclosure may be flat and unbent while being extended lengthwise in a direction approximately parallel to the lateral direction.

In the unbent state, the clip 140 has one surface seated on the blade housing 100 and the other surface pressed by the cover housing 150 to form the first elongated portion 144, the second elongated portion 146, and the third elongated portion 148. Accordingly, using a simple combination process, the position of the clip 140 may be fixed and the pressing force on the at least one razor blade 120 may be maintained.

However, the third elongated portion 148 does not necessarily have to be formed only by combining the blade housing 100 and the cover housing 150. It is also possible that the clip 140 is configured to include the first elongated portion 144, the second elongated portion 146, and the third elongated portion 149 beforehand before the blade housing 100 and the cover housing 150 are combined.

In addition, the blade housing 100 may include a third stop surface 760, and the cover housing 150 may include a fourth stop surface 780.

The third stop surface 760 may be configured so that at least a portion of a lateral side end of the first support portion 500 supports one surface of the third elongated portion 148. For example, referring to FIG. 7, the third stop surface 760 supports one surface of the third elongated portion 148 in the lateral direction, thereby preventing the clip 140 from moving in the lateral direction. In order to prevent the clip 140 from moving in the lateral direction, it may be desirable for the third stop surface 760 to be approximately parallel to the extension direction of the third elongated portion 148, without being necessarily limited thereto.

The fourth stop surface 780 may extend from the second support portion 550 toward the bottom surface, at least a portion of which is configured to support the other surface opposite to one surface of the third elongated portion 148. For example, the fourth stop surface 780 may be opposite to the third stop surface 760 in the lateral direction. In this connection, in at least one region of the razor cartridge 20 according to another embodiment of the present disclosure, the third stop surface 760, the third elongated portion 148, and the fourth stop surface 780 may be formed in order along a direction approximately parallel to the lateral direction.

Accordingly, the third stop surface 760 and/or the fourth stop surface 780 together with the first stop surface 560 and/or the second stop surface 580 may further prevent the clip 140 from moving in the lateral direction.

As described above, the razor cartridges 10 and 20 according to one and another embodiments of the present disclosure reduce manufacturing costs by fixing the clip 140 to the blade housing 100 through a simple process, and simultaneously enables the clip 140 to be separated for discharge.

The spirit of the present embodiment is illustratively described hereinabove. It will be appreciated by those skilled in the art to which the present embodiment pertains that various modifications and alterations may be made without departing from the essential characteristics of the present embodiment. Accordingly, the present embodiments are not to limit the spirit of the present embodiment, but are to describe the spirit of the present embodiment. The technical idea of the present embodiment is not limited to these embodiments. The scope of the present embodiment should be interpreted by the following claims, and it should be interpreted that all the spirits equivalent to the following claims fall within the scope of the present embodiment.

What is claimed is:

1. A razor cartridge, comprising:
a blade housing configured to accommodate at least one razor blade comprising a cutting edge in a longitudinal direction, the blade housing comprising a top surface toward which the cutting edge faces and a bottom surface opposing the top surface;
a clip comprising:
a clip body disposed on the top surface and configured to retain the at least one razor blade in the blade housing,
a first elongated portion extending from the clip body toward the bottom surface, and
a second elongated portion extending from one end of the first elongated portion in a direction away from the center of the clip body; and
a cover housing configured to be combined with the blade housing in a direction from the top surface to the bottom surface,
wherein the second elongated portion is disposed between the blade housing and the cover housing.

2. The razor cartridge of claim 1, wherein a position of the clip is fixed by combining the blade housing and the cover housing.

3. The razor cartridge of claim 1, wherein the first elongated portion and the second elongated portion are formed by combining the blade housing and the cover housing.

4. The razor cartridge of claim 1, wherein at least a portion of the clip body is exposed to the outside on the top surface.

5. The razor cartridge of claim 1, wherein one end of the first elongated portion and one end of the second elongated portion are disposed between the top and bottom surfaces.

6. The razor cartridge of claim 1, wherein an extension direction of the first elongated portion and an extension direction of the second elongated portion are different from each other.

7. The razor cartridge of claim 1, wherein the cover housing comprises a central opening portion configured to enable the blade housing to pass through a central region of the cover housing.

8. The razor cartridge of claim 1, wherein:
the blade housing comprises a first support portion comprising a first support surface formed at front and/or rear of the blade housing, so that at least a portion of the first support surface is configured to support a lower portion of the second elongated portion, and
the cover housing comprises a second support portion comprising a second support surface parallel to an extension direction of the first support surface, so that at least a portion of the second support surface is configured to support an upper portion of the second elongated portion.

9. The razor cartridge of claim 1, wherein the blade housing comprises a first stop surface formed at front and/or rear of the blade housing, so that at least a portion of the first stop surface is configured to support one surface of the first elongated portion.

10. The razor cartridge of claim 1, wherein the cover housing comprises a second stop surface, opposite to at least a portion of the blade housing, at least a portion thereof configured to support the other surface of the first elongated portion.

11. The razor cartridge of claim 1, wherein the clip further comprises a third elongated portion extending from one end of the second elongated portion toward the bottom surface.

12. The razor cartridge of claim 8, wherein:
the clip further comprises a third elongated portion extending from one end of the second elongated portion toward the bottom surface,
the blade housing comprises a third stop surface at least a portion thereof configured to support one surface of the third elongated portion, at an end of the first support portion in a lateral direction perpendicular to the longitudinal direction, and
the cover housing comprises a fourth stop surface, extending from the second support portion toward the bottom surface, at least a portion thereof configured to support the other surface opposite to one surface of the third elongated portion.

13. The razor cartridge of claim 11, wherein an extension direction of the third elongated portion and an extension direction of the second elongated portion are different from each other.

14. The razor cartridge of claim 1, wherein the cover housing comprises a pair of side openings formed on both longitudinal side areas of the cover housing to allow rinsing water to pass through the blade housing in a region adjacent to both longitudinal side surfaces of the at least one razor blade.

15. The razor cartridge of claim 14, wherein the cover housing comprises a pair of side walls disposed below each of the pair of side openings and configured to support at least a portion of one longitudinal side surface of the at least one razor blade when the blade housing is viewed from one longitudinal side.

16. The razor cartridge of claim 1, further comprising a first lubrication band disposed on one surface adjacent to the top surface of the cover housing,
wherein one end in the longitudinal direction of the first lubrication band is disposed closer to one end in the longitudinal direction of the cover housing than one end in the longitudinal direction of the clip.
